(19) United States
(12) Patent Application Publication
(10) Pub. No.: US 2018/0292935 A1
(43) Pub. Date: Oct. 11, 2018

(54) TOUCH MODULE WITH FINGERPRINT IDENTIFICATION DEVICE

(71) Applicant: KEYCORE TECHNOLOGY CORP., Zhubei City (TW)

(72) Inventors: Wei-Cheng Lin, Zhubei City (TW); Chien-Jen Hsiao, Zhubei City (TW); Shih-Hsiu Tseng, Zhubei City (TW)

(21) Appl. No.: 15/495,984

(22) Filed: Apr. 25, 2017

(30) Foreign Application Priority Data
Apr. 11, 2017 (TW) 106112018

(51) Int. Cl. G06F 3/041; G06K 9/00; G06F 3/044

(52) U.S. Cl. CPC G06F 3/0412; G06F 3/044; G06K 9/0004

(57) ABSTRACT

A touch module with fingerprint identification device includes a substrate section, a circuit layer and a protection layer. The substrate section has a first face and a second face. The first face has multiple display blocks. Each display block is composed of multiple LED light-emitting diodes, multiple infrared light-emitting diodes and multiple detectable infrared diodes. The circuit layer has multiple circuit wires. The circuit wires are disposed on the first face of the substrate section and respectively electrically connected with the display blocks. The protection layer is correspondingly disposed on the first face of the substrate section to cover the first face. In the touch module, the display section and the fingerprint identification section are integrated, whereby when performing the fingerprint identification work, the picture can be still displayed.

This application claims the priority benefit of Taiwan patent application number 106112018 filed on Apr. 11, 2017.

### BACKGROUND OF THE INVENTION

### 1. Field of the Invention

The present invention relates generally to touch module with fingerprint identification device, and more particularly to a touch module with fingerprint identification device, in which the display section and the fingerprint identification section are integrated, whereby when performing the fingerprint identification work, the display work can be still performed.

### 2. Description of the Related Art

The current mobile devices or notebooks or security access control systems have popularly employed fingerprint identification devices for security identification. The fingerprint identification device is often independently disposed in a region of the mobile device and rarely integrated with the touch and display sections of the mobile device. This is because it is hard to integrate the display work and the fingerprint identification work to perform these works at the same time. Therefore, the fingerprint identification device is independently disposed in a region of the mobile device. Some manufacturers arrange the fingerprint identification device on the back cover of the mobile device, while some manufacturers arrange the fingerprint identification device on the non-touch section of the touch screen of the mobile device. Such arrangement has a shortcoming that in case the fingerprint identification device of the mobile device is operated in a dark place, the fingerprint identification region has no illumination display so that it is quite inconvenient to operate the fingerprint identification device.

It is therefore tried by the applicant to provide a touch module with fingerprint identification device, in which the fingerprint identification device is integrated with the display section of the mobile device to solve the above shortcoming.

### SUMMARY OF THE INVENTION

It is therefore a primary object of the present invention to provide a touch module with fingerprint identification device, in which the fingerprint identification section of the mobile device is integrated with the display section of the mobile device.

It is a further object of the present invention to provide a touch module with fingerprint identification device, which has complex touch detection function.

To achieve the above and other objects, the touch module with fingerprint identification device of the present invention includes a substrate section, a circuit layer and a protection layer.

The substrate section has a first face and a second face. The first face has multiple display blocks. Each display block is composed of multiple LED light-emitting diodes, multiple infrared light-emitting diodes and multiple detectable infrared diodes.

The circuit layer has multiple circuit wires. The circuit wires are respectively electrically connected with the display blocks. The protection layer is correspondingly disposed on the first face of the substrate section to cover the first face.

In the touch module of the present invention, the fingerprint identification section and the display section are integrated to improve the shortcoming of the conventional device that the display section cannot be integrated with the fingerprint identification section.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a first embodiment of the fingerprint identification device of the present invention;

FIG. 2 is a top view of the first embodiment of the fingerprint identification device of the present invention;

FIG. 3 is a schematic view of the first embodiment of the fingerprint identification device of the present invention, showing the operation thereof;

FIG. 4 is another schematic view of the first embodiment of the fingerprint identification device of the present invention, showing the operation thereof; and

FIG. 5 is a perspective exploded view of a second embodiment of the fingerprint identification device of the present invention.

### DETAILED DESCRIPTION OF THE PREFERRED EMBODIMENTS

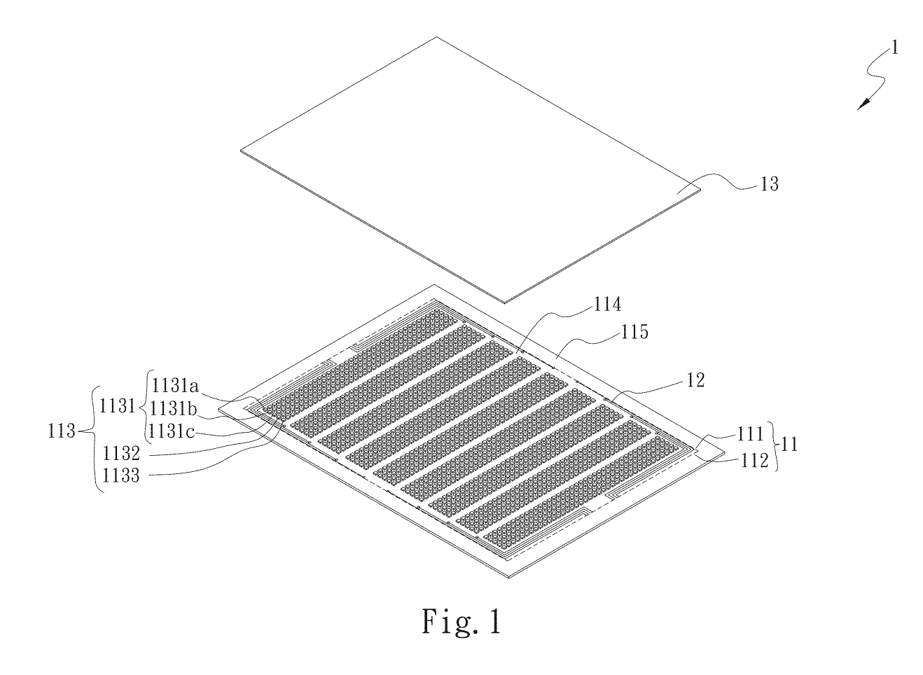

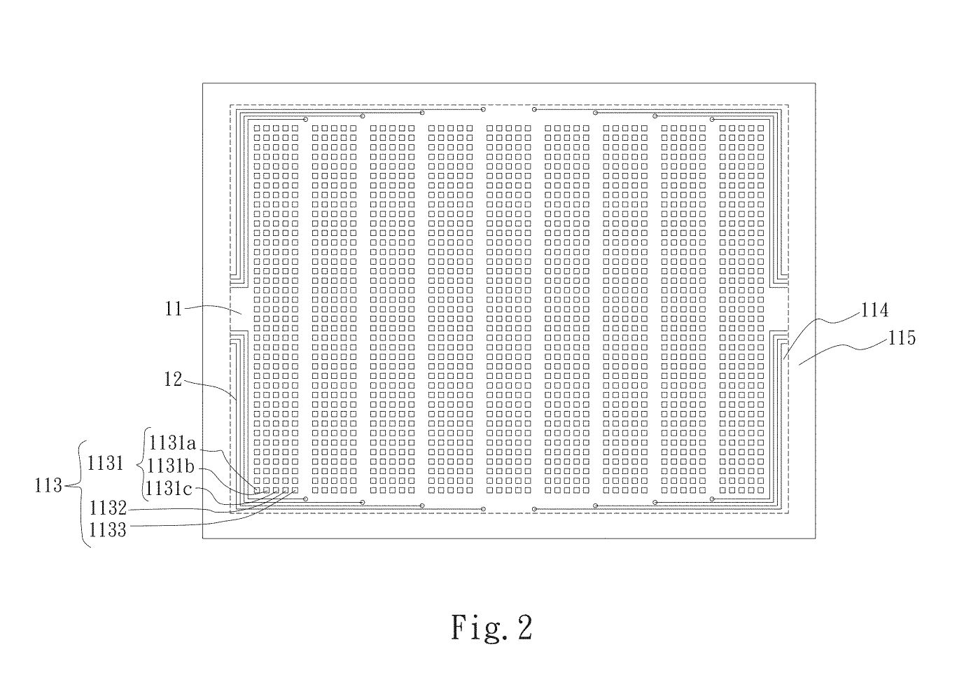

Please refer to FIGS. 1 and 2. FIG. 1 is a perspective view of a first embodiment of the touch module with fingerprint identification device of the present invention. FIG. 2 is a top view of the first embodiment of the touch module with fingerprint identification device of the present invention. According to the first embodiment, the fingerprint identification device 1 of the present invention includes a substrate section 11, a circuit layer 12 and a protection layer 13.

The substrate section 11 has a first face 111 and a second face 112. The first face 111 has multiple display blocks 113. Each display block 113 is composed of multiple LED light-emitting diodes 1131, multiple infrared light-emitting diodes 1132 and multiple detectable infrared diodes 1133.

The LED light-emitting diodes 1131 of the display block 113 include multiple red LED light-emitting diodes 1131a, multiple green LED light-emitting diodes 1131b and multiple blue LED light-emitting diodes 1131c. The LED light-emitting diodes 1131 are horizontally arranged in array at intervals. The infrared light-emitting diodes 1132 and the detectable infrared diodes 1133 are also horizontally arranged in array at intervals.

The display block 113 can be a 5×5 or an over 5×5 array block composed of the LED light-emitting diodes 1131, the infrared light-emitting diodes 1132 and the detectable infrared diodes 1133 arranged in array at intervals. Multiple display blocks 113 arranged in array extend in the longitudinal and transverse directions of the substrate section 11.

The external size or length of the LED light-emitting diodes 1131, the infrared light-emitting diodes 1132 and the detectable infrared diodes 1133 ranges from 1 μm to 100 μm and the width ranges from 1 μm in to 100 μm.

The circuit layer 12 has multiple circuit wires. The circuit wires are disposed on the first face 111 of the substrate section 11 and respectively electrically connected with the display blocks 113.

The protection layer 13 is correspondingly disposed on the first face 11 of the substrate section 11 to cover the first face 111. The protection layer 13 is selected from a group consisting of glass, flexible polymer material and thin film material. In this embodiment, the protection layer 13 is, but not limited to, a glass for illustration purposes only.

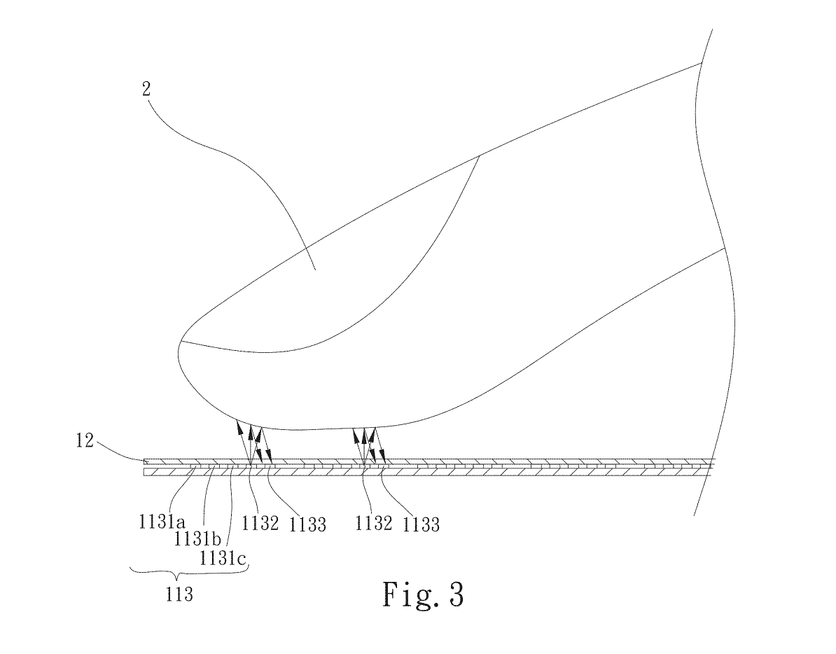

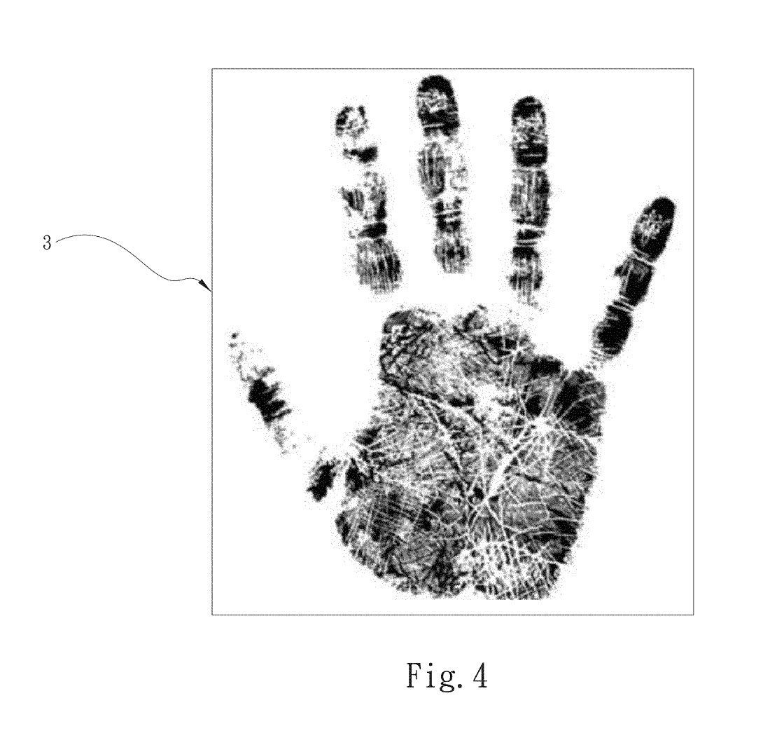

Please now refer to FIGS. 3 and 4. FIG. 3 is a schematic view of the first embodiment of the touch module with fingerprint identification device of the present invention, showing the operation thereof. FIG. 4 is another schematic view of the first embodiment of the touch module with fingerprint identification device of the present invention, showing the operation thereof. As shown in the drawings, in the fingerprint identification device of the present invention, the infrared light-emitting diodes 1132 and the detectable infrared diodes 1133 are integrated with and added into the display blocks 113 for detecting the fingerprint. When the fingerprint is identified, the display blocks 113 can still display figures or characters.

Each display block 113 is composed of multiple red LED light-emitting diodes 1131a, multiple green LED light-emitting diodes 1131b and multiple blue LED light-emitting diodes 1131c arranged in array at intervals. The three different colors of LED light-emitting diodes serve to perform the display work. In addition, the infrared light-emitting diodes 1132 and the detectable infrared diodes 1133 integrated in the display block 113 serve to cooperatively perform the fingerprint identification work.

The substrate section 11 has a touch section 114 and a non-touch section 115. The non-touch section 115 is disposed around the touch section 114. The display blocks 113 are disposed in the touch section 114.

When the system detects to perform the fingerprint or palm print identification work, the infrared light-emitting diodes 1132 will emit infrared waveband. When the object (the fingerprint of a finger 2 or the palm print of a palm 3) gets close, the infrared waveband emitted by the infrared light-emitting diodes 1132 will be reflected to the detectable infrared diodes 1133 positioned nearby.

The amount of the reflected infrared ray is determined by the recessed/raised configuration of the object such as the fingerprint or the palm print. Therefore, a figure of the fingerprint or the palm print is produced. Moreover, by means of the black-and-white infrared waveband emitted by the infrared light-emitting diodes 1132, the characteristics of the detected object (the fingerprint or the palm print) are highlighted so that the identification precision is enhanced.

In the present invention, the infrared waveband emitted by the infrared light-emitting diodes 1132 hits and is reflected by the detected object and received by the detectable infrared diodes 1133. In the meantime, the red LED light-emitting diodes 1131a, the green LED light-emitting diodes 1131b and the blue LED light-emitting diodes 1131c still emit light to display and produce the necessary image for the user, such as the palm print figure (as shown in FIG. 4). It can be a video or a figure or produced fingerprint or palm print figure. Therefore, the present invention integrates the display and fingerprint identification.

The infrared light-emitting diodes 1132 and the detectable infrared diodes 1133 also have the function of detecting the touch position. When the user simply performs the touch work, the infrared light-emitting diodes 1132 still can emit infrared ray to hit the approaching object (the finger or the palm). The infrared ray is reflected to be received by the detectable infrared diodes 1133 for judging the position of the approaching object. The point for the fingerprint identification is first detected and then switched to perform the fingerprint identification work. Therefore, in case it is necessary to perform both of the touch work and the fingerprint identification work, the infrared light-emitting diodes 1132 and the detectable infrared diodes 1133 will first judge the position of the position of the object (touch point detection work). After confirmed, it is switched to perform the fingerprint identification work. Accordingly, the two works can be switched by means of time difference.

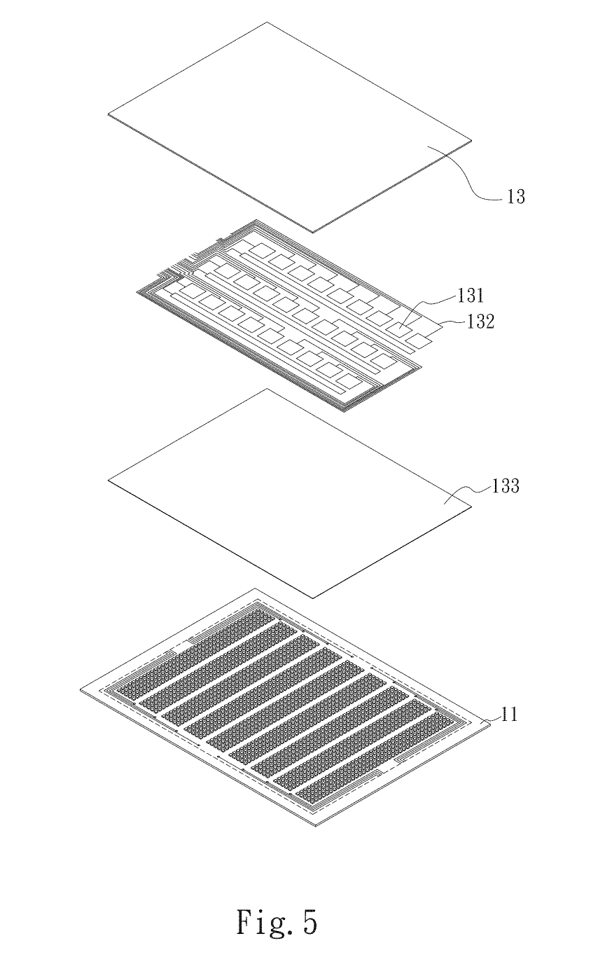

Please now refer to FIG. 5, which is a perspective exploded view of a second embodiment of the touch module with fingerprint identification device of the present invention. The second embodiment is partially identical to the first embodiment in structure and thus will not be repeatedly described hereinafter. The second embodiment is different from the first embodiment in that the protection layer 13 is a glass substrate. Multiple touch electrodes 131, multiple touch circuits 132 and an insulation layer 133 are disposed on one face of the protection layer 13 facing the substrate section 11. The touch electrodes 131 and the touch circuits 132 are electrically connected to each other. The insulation layer 133 is overlaid on the touch electrodes 131 and the touch circuits 132.

The substrate section 11 has a touch section 114 and a non-touch section 115. The non-touch section 115 is disposed around the touch section 114. The touch electrodes 131 and the touch circuits 132 are disposed in the touch section 114.

In this embodiment, the touch electrodes 131 and the touch circuits 132 are additionally disposed on one face of the protection layer 13 to integrate the touch function. The protection layer 13 can be selectively a touch module, whereby the three functions of touch, display and fingerprint identification are integrated into one. Accordingly, the user can perform the three works of touch, display and fingerprint identification in the same block at the same time.

In this embodiment, a capacitive touch structure is integrated with the structure of the first embodiment. In case it is necessary to perform both of the touch function and the fingerprint identification function, the touch electrodes 131 can help in performing the touch function. The fingerprint identification work can be successfully performed without conflicting with the touch function.

Alternatively, the substrate section 11 of the present invention can be selectively any material or part, whereby the display blocks are directly integrally disposed on the substrate section 11. The positions where the display blocks are disposed have the basic display function as well as the fingerprint identification function and the touch function. The substrate section 11 is selected from a group consisting of a substrate of an LED display and a substrate of a touch screen.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A touch module with fingerprint identification device, comprising:
a substrate section having a first face and a second face, the first face having multiple display blocks, each display block being composed of multiple LED light-emitting diodes, multiple infrared light-emitting diodes and multiple detectable infrared diodes;
a circuit layer having multiple circuit wires, the circuit wires being disposed on the first face of the substrate section and respectively electrically connected with the display blocks; and
a protection layer correspondingly disposed on the first face of the substrate section to cover the first face.

2. The touch module with fingerprint identification device as claimed in claim 1, wherein the LED light-emitting diodes of the display block include multiple red LED light-emitting diodes, multiple green LED light-emitting diodes and multiple blue LED light-emitting diodes, the LED light-emitting diodes being horizontally arranged in array at intervals.

3. The touch module with fingerprint identification device as claimed in claim 1, wherein the infrared light-emitting diodes and the detectable infrared diodes are horizontally arranged in array at intervals.

4. The touch module with fingerprint identification device as claimed in claim 1, wherein the protection layer is selected from a group consisting of glass, flexible polymer material and thin film material.

5. The touch module with fingerprint identification device as claimed in claim 1, wherein the display block is a 5×5 or an over 5×5 array block.

6. The touch module with fingerprint identification device as claimed in claim 1, wherein the external length of the LED light-emitting diodes, the infrared light-emitting diodes and the detectable infrared diodes ranges from 1 μm to 100 μm and the width ranges from 1 μm to 100 μm.

7. The touch module with fingerprint identification device as claimed in claim 1, wherein the protection layer is a glass substrate, multiple touch electrodes and multiple touch circuits being disposed on one face of the protection layer facing the substrate section, the touch electrodes and the touch circuits being electrically connected to each other.

8. The touch module with fingerprint identification device as claimed in claim 1, wherein the substrate section has a touch section and a non-touch section, the non-touch section being disposed around the touch section, the display blocks being disposed in the touch section.

9. The touch module with fingerprint identification device as claimed in claim 7, wherein the substrate section has a touch section and a non-touch section, the non-touch section being disposed around the touch section, the touch electrodes and the touch circuits being disposed in the touch section.

10. The touch module with fingerprint identification device as claimed in claim 1, wherein the substrate section is selected from a group consisting of a substrate of an LED display and a substrate of a touch screen.
